(19) United States
(12) Patent Application Publication
(10) Pub. No.: US 2004/0021035 A1
(43) Pub. Date: Feb. 5, 2004

(54) Concept of increasing efficiency conversion kinetic energy working substance in linear and rotary force

(76) Inventor: Lev Pribytkov, Orange, NJ (US)

Correspondence Address: Lev Pribytkov, 355 Thomas Blv. 3F, Orange, NJ, 07050-4120, US

(21) Appl. No.: 10/266,134

(22) Filed: Mar. 26, 2003

Related U.S. Application Data
(63) Continuation-in-part of application No. 08/583,248, filed on Jan. 5, 1996, now Pat. No. 5,691,921.

(51) Int. Cl. B64C 27/00; B64C 39/00

(52) U.S. Cl. 244/62

(57) ABSTRACT

A concept of design rotary and linear engines pursuing increasing effectiveness by employment centrifugal force is creating by laminar movement whole working substance in rigid walls channel:

The concept suggests employing centrifugal force of movement whole working substance in rigid walls channel instead and additionally to straight backward one used now in linear movers.

The concept suggests employing centrifugal force movement whole working substance instead effect of hit and reflection one used now in rotary engines.

### OBJECT OF THE INVENTION

The present invention relates to linear and rotary engines, and more particular to the increasing effectiveness engines converting kinetic energy of movement working substance in a linear or rotary force.

### BACKGROUND OF THE INVENTION

A basic design linear and rotary engines converting kinetic energy of movement working substance in a linear or rotary force has been evaluated for over 50 years and it employs Principle of Conservation of Momentum:

M*V=m*v

A linear mover with direct employment this Law is used in space and air due its very low effectiveness—about 1% for ordinary and 2-3% for the advanced models. One side equation represents a product of mass and speed of a craft, and another side represents a product of mass and speed of leaving burned fuel.

Some similarity with suggested concept is found in nine US patents:

1. PROPELLING DEVICE # U.S. Pat. No. 2,108,652 issued on Feb. 15, 1938(in France Jan. 15, 1935) to H. Coanda. It employs airfoil components for creation a linear force. A working substance passes part its way in rigid channel but the rigid passage intended for auxiliary task and situated in a way offsetting resultant centrifugal force. Indeed a tube 5 can create some limited centrifugal force in one direction, however a working substance creates another centrifugal forces in exactly opposite direction in parts the passage 9 and 2. Combination these factors made his design impractical.

2. AERODYNAMIC IMPELLING DEVICE # U.S. Pat. No. 2,468,787 issued on May 13, 1949 to J S. Sharpe. It also employs airfoil components for creation a linear force. It employs roughly 60% curvilinear way gases over airfoil surface. It has also roughly 40% curvilinear way gases under rigid curvilinear surface that can create centrifugal force. However due law nature requiring passage any matter or energy by way of the least resistance, apparently practically all working substance passes by that rigid curvilinear surface excluding employment centrifugal force. Combination these factors and chaotic multiple hits with reflections micro jets surfaces passages made his design also impractical for increasing efficiency the engine.

3. REACTION PROPULSION SYSTEM FOR AIRCRAFT # U.S. Pat. No. 2,523,938 issued on Sep. 26, 1950 to H. A. Berlinder. The design is distributing fluid symmetrically in two engine aircraft in order prevention directional unbalance in case failure one engine. It has considerable rigid curvilinear surface that can create centrifugal force. However due law nature requiring passage any matter or energy by way of the least resistance, apparently practically all working substance passes by the rigid curvilinear surface excluding employment centrifugal force.

4. BOOSTER ROCKET # U.S. Pat. No. 3,224,370 issued on Dec. 21, 1965 to Richard Vogt, A design is providing termination thrust by means for deflection at least a portion of an exhaust gases from a rocket nozzle. It has considerable rigid curvilinear surface that can create centrifugal force. However due law nature requiring passage any matter or energy by way of the least resistance, apparently practically all working substance passes by the rigid curvilinear surface excluding employment centrifugal force. In addition his design of curved features is moveable.

5. THRUST REVERSING APPARATUS # U.S. Pat. No. 3,601,992 issued on Aug. 31, 1970 to Richard Maison. The design of means of jet engine for reverse the direction of flow of jet stream during landing runs to produce a reverse thrust. It employs traditional straight backward movement working substance by deflection its stream. It has considerable rigid curvilinear surface that can create centrifugal force. However the Law of Nature dictates to fluid pass via a way of the least resistance, therefore a working substance straightens its way for bypassing curved path and therefore excludes or drastically reduces created centrifugal force. His design of curved features is also moveable.

6. PROPELLING NOZZLE FOR MEANS OF TRANSPORT IN AIR OR WATER # U.S. Pat. No. 4,192,461 issued on Mar. 11, 1980 to Ole Arborg. A design of transport vehicles in air or water utilizing injection pressured fluid under acute angle in surrounded portion media. It has rigid curvilinear surface that can create centrifugal force. However due law nature requiring passage any matter or energy by the way of least resistance, apparently practically all working substance passes by the rigid curvilinear surface excluding employment centrifugal force.

7. Patent # U.S. Pat. No. 2,937,496 issued on May, 24, 1960 to Gaillette, has rigid curvilinear surface that can create centrifugal force. However due law nature requiring passage any matter or energy by the way of the least resistance, apparently practically all working substance passes by the rigid curvilinear surface. In addition apparently multiple hits and reflections small spurts of walls cause exclusion employment centrifugal force in such design of engine.

8. Pat. No. 3,112,616 issued on Dec. 3, 1963 to Adamson, has rigid curvilinear surface that can create centrifugal force. However due law nature requiring passage any matter or energy by the way of the least resistance, apparently practically all working substance passes by the rigid curvilinear surface excluding employment centrifugal force. It apparent multiple hits and reflections small spurts of blades cause exclusion employment centrifugal force in such design of engine. In addition his design of curved features is moveable.

9. Pat. No. 4,901,947 issued on Feb. 20, 1990 to Raymer does not predict increase efficiency his design of engine apparently considering lack evidence power loss in engines employed by British Harrier and Russian YAK-36 having some curvilinear passage able to create backward centrifugal force. Its design has rigid curvilinear surface that can create centrifugal force. However due intervention law nature requiring passage any matter or energy by way of the least resistance, apparently practically all working substance passes by the rigid curvilinear surface without creating centrifugal force and thus without transferring its kinetic energy to an engine. In addition apparently multiple hits and reflections small spurts of walls cause exclusion employment centrifugal force in such design of engine.

This problem is complicated by exclusively low friction between layers gases preventing transfer kinetic energy moving whole passing working substance to outer curvilinear wall in form centrifugal force. The transfer kinetic energy of moving liquid to curvilinear surface causes loss speed of its one molecule layer contacting outer curvilinear wall. The next one molecule layer transfers a small part its kinetic energy to the first one molecule layer of liquid by causing it to move faster but due very low coefficient of friction it transfers only a very small portion its energy. The pattern repeats in reference the third one molecule layer that transfers a small part its kinetic energy to the second one molecule layer of liquid by causing it to move faster but due very low coefficient of friction it transfers only a very small portion its energy. That means every next one molecule layer of liquid transfers less its kinetic energy to the first one molecule layer of liquid contacting curvilinear surface and therefore contributes less energy to creating the centrifugal force. As a result actually only several hundreds or thousands one molecule layers of liquid transfer a very small part their kinetic energy to the first one molecule layer of liquid that really is able to transfer energy to the curvilinear surface. That means all the rest mass of the liquid working substance passes by the curvilinear channel without transferring kinetic energy. In addition chaotic movement small spurts of liquid in current engines produced by fierce fuel burning cause apparently multiple hits and reflections of walls that make excessive noise and drastically reduce size of centrifugal force in current design of engines especially turbines.

A current rotary engine (turbine) employs this Law indirectly, by causing jet hit and reflection its blades. In a big size and in a narrow mode of operation such design allows reaching the best effectiveness, about 35%. However, it is uncommon, obviously due a small angle of reflection, possibility of passing engine without clash, and a presence uncontrolled secondary hits and reflections the blades by small spurts of liquid of working substance.

These considerations show that the highest efficiency linear and rotary engines can be attained with discrete form working substance or one layer liquid or gas form working substance and one has go for a compromise between number layers liquid employed and ability industry to manufacture narrowest passage for the liquid. However in overall multiple even say one-millimeter wide passages will allow manufacture number models linear and rotary engines with drastically increased efficiency suitable for number applications in earth environment. Importance linear engines based on this concept on space environment for correction and maintenance orbit satellites impossible overestimate! The same applies for space nuclear electric power units using turbines employing this concept! Another factor defining efficiency is radius of curvilinear movement substance along with angle. The most efficient conversion should be considered when radius the movement approaches to zero and angle semicircle is approaching to 180°. Yet another feature increasing endurance such engine is covering its working surface with durable layer like ceramic coating.

The invention allows:

Obtain as rotary and so linear force with increased effectiveness by reducing possibility passing an engine by working substance without converting speed in force, and eliminating conditions for uncontrolled secondary hits and reflections small spurts of liquid of walls or blades of turbine;

Get stable in active movement rocket due possibility to install the mover before its center gravity;

Design economical, simple and so more reliable speedy and slow flying vehicle for lifting and transportation sizable and heavy loads, and therefore perfectly fit for controlling forest fires;

Design reliable, small sized, simple, and economical means for securing aircraft from uncontrolled downfall in the most accidents by attaching such design small sized solid fuel engines to fuselage of aircraft;

Design reliable, small sized, simple, and economical engines for interstellar trips without expulsion mass;

Design turbines increased efficiency for Earth and space environment.

### BRIEF DESCRIPTION OF THE DRAWINGS

FIG. 1 illustrates a basic suggested design of linear mover excellent stability for big sized rotorless vehicles.

FIG. 2. illustrates a suggested design of linear mover with a single annular nozzle.

FIG. 3. illustrates suggested design of linear mover with multiplied (double) annular nozzle.

FIG. 4 illustrates a modification suggested design adjusted to a rotary engine with radial channels.

FIG. 5. illustrates another modification suggested design adjusted to a rotary engine with axial channels.

FIG. 6. illustrates design engine without expelling mass by employing movement ball, liquid or ionized gas in circle with different radius on opposite sides.

FIG. 7. illustrates design engine without expelling mass by employing movement ball liquid or ionized gas in circle with different speed on opposite sides.

### DESCRIPTION OF THE PREFERRED EMBODIMENTS

The present invention is directed to increasing effectiveness engines converting kinetic energy of movement working substance in linear or rotary force.

The system with increased effectiveness jet force utilizes a novel design of a channel of nozzle for movement working substance by reducing a distance between curvilinear walls and increasing width of ribbon shaped channel in such way that substantial increase effectiveness achieved since centrifugal force of a maximal speed movement working substance in a channel formed of less two diameter molecules liquid said distance between curvilinear walls and maximally said increasing their width with a radius said a channel of minimal size is employed.

The invention allows:

Obtain as rotary and so linear force with increased effectiveness by reducing possibility passing an engine by working substance without converting speed in force, and eliminating conditions for uncontrolled secondary hits and reflections small spurts of liquid of walls or blades of turbine;

Get stable in active movement rocket, due possibility to install the mover before its center gravity;

Design economical, simple and so more reliable speedy and slow flying vehicle for lifting and transportation sizable and heavy loads, and therefore perfectly fit for controlling forest fires;

Design reliable, small sized, simple, and economical means for securing aircraft from uncontrolled downfall in the most accidents by attaching such design small sized solid fuel engines to fuselage of aircraft;

Design reliable, small sized, simple, and economical engines for interstellar trips without expulsion mass;

Design turbines increased efficiency for Earth and space environment.

Design gas and hydraulic turbines increased efficiency.

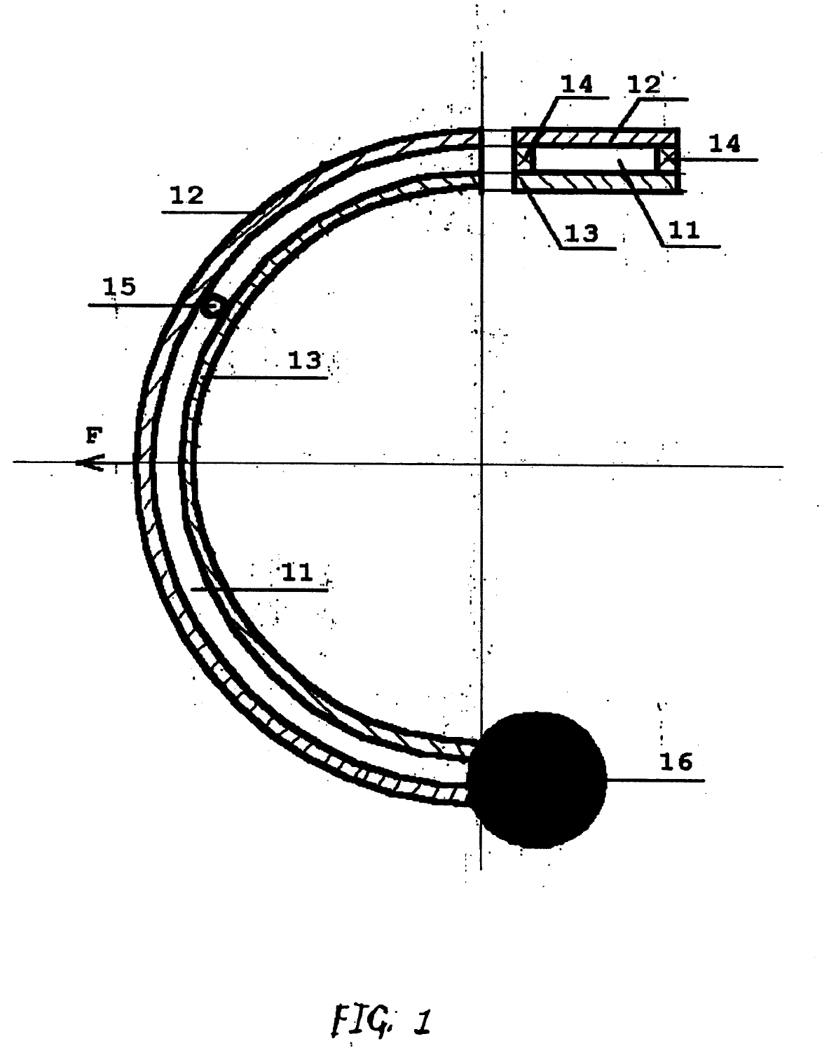

Referring to FIG. 1, there are shown two sections of a linear mover employing suggested design of centrifugal converter kinetic energy of movement working substance in a motive force. This engine comprises a channel 11 formed by an outer curved wall 12, an inner curved wall 13, and two side walls 14.

Let's assume that surfaces 11 and 12 contain chain electric magnets are feeding with 3-phase voltage for creating running electromagnetic field A good example employment this effect is a system planned by NASA for launch mini satellites to Mars from Earth orbit with running electromagnetic field. One side of bellow equitation represents a product of mass and speed of a craft, and another side represents a product of mass and speed of leaving mini satellite. The basic design linear engines converting kinetic energy movement gas working substance in a linear force and has been evaluated for about 100 years, and it exploits Principle Conservation of Momentum:

M·V=m·v

One can employ for it centrifugal force is creating by movement of liquid or solid (ball or rod), working substance with running electromagnetic field for exploitation Natural Law:

$$A : {F}_{C} = \int * m * t * \frac{V * V}{R} \begin{matrix}contrary currently used \\ \begin{matrix}empirical expression for \\ calculation {F}_{J} jet engines : \end{matrix}\end{matrix} B : {F}_{J} = V * m * sec$$

A movement working substance, in this example a metal ball or rod creates a resultant centrifugal force F_{c} of shown direction in accordance with the formula:

The: F_{c}—represents centrifugal force;

m—represents mass of working substance;

v—represents speed of working substance;

r—represents a radius of curved way of working substance.

∫—integral sin 0→180°=1.41

And applied to the middle of outer wall of curved channel.

| | |
|---|---|
| Say using working substance of: | m = 2 kg |
| with a radius of way: | R = 0.5 m |
| and providing it speed: | V₁ = 2 m * sec with interaction t = 3/2 = 1.5 sec |
| | V₂ = 4 m * sec with interaction t = 3/4 = 0.75 sec |
| | V₃ = 6 m * sec with interaction t = 3/6 = 0.5 sec |
| | V₄ = 20 m * sec with interaction t = 3/20 = 0.15 sec |

one gets

| A: | | B: |
|---|---|---|
| F₁ = 34.84 kg * m * sec² | contrary | F₁ = 4 kg * m * sec² |
| F₂ = 67.68 kg * m * sec² | contrary | F₂ = 8 kg * m * sec² |
| F₃ = 101.5 kg * m * sec² | contrary | F₂ = 12 kg * m * sec² |
| F₄ = 338.1 kg * m * sec² | contrary | F₃ = 40 kg * m * sec² |

The numbers show drastic increase efficiency conversion kinetic energy in linear force relevant to speed increase.

One has admit that increase efficiency conversion kinetic energy movement working substance in linear force with centrifugal force is secured and it does not matter physical state of working substance. The same increase efficiency will be granted by Nature for solid, liquid, and gaseous working substance. It also does not matter nature movement working substance. The same effect will be granted for movement with running electromagnetic, electrostatic, piezoelectric field and under pressure burning fuel.

Although curvilinear movement the same mass working substance with equal speed requires more energy, it is obvious that employment centrifugal force outweighs loss energy to it and increased friction along surface channel and increases overall efficiency the engine.

We have to note that math expression centrifugal force shows possibility double efficiency conversion kinetic energy movement working substance in linear force and it does not matter physical state of working substance. The same double increase efficiency will be granted by Nature for solid, liquid, and gaseous working substance.

Another consideration is that the integral force produced by curvilinear movement will be vector with maximum in the targeted direction and reduced to zero at start and exit ends of the path due their equivalency and opposite directions.

Such design spreads application centrifugal force over lengthy and wide surface and therefore reduces specific load on a surface of nozzle.

The best efficiency attainable by this version engine would be channel allowing movement between one and two layers of liquid and practically attainable width the channel will be width allowing close to laminar movement liquid working substance.

The following consideration expose possibility design centrifugal engine without expelling mass.

And applied to the middle of outer wall 12 of curved channel 11.

Let's arrange a ball to move in semicircle with constant speed that can be managed with controlled speed of running electromagnetic field on one or two sides the channel. One can be reached in a spiral channel designed in such way that during acceleration movement the ball's vector force equals zero. This goal can be attained by variation rate acceleration combined with length coils of spiral used for achievement targeted speed of the ball at the beginning considered semicircle.

If the speed of the ball is constant during passing entire semicircle, the engine gets summary force Fₛ equal to F_{c} created by centrifugal force combined with Fⱼ force applied according Principle Conservation of Momentum:

$${F}_{S} = {F}_{C} + {F}_{J} = m * \frac{V * V}{r} + V * m * sec ;$$

This feature is especially valuable for interstellar space travel, where weight spaceship that includes with weight fuel is a critical matter.

Let's explore case where circular movement a ball occurs without power feed: The ball possessing starting speed Bₛₜ possessing kinetic energy Kₛₜ during circular movement creates centrifugal force F_{c} applying roughly to middle semicircle. This centrifugal force moves the engine when the ball reaches the end channel with speed say V₁. Therefore on exit semicircle the ball has speed B₂:

B₂=Bₛₜ−V₁;

Accordingly, the ball gives part its kinetic energy K₁ to engine via the centrifugal force and it means its kinetic energy reduces say to:

| | |
|---|---|
| K_{B2} = K_{Bst} − K₁; | Accordingly kinetic energy engine K_{E} will be: |
| K_{E} = K_{Est} + K₁; | If say K₁ = 10% the ball on exit the semicircle gets kinetic energy: |
| K_{B} = K_{Bst} − 0.1 K_{Bst} | and the engine gets kinetic energy: |
| K_{E} = K_{Est} + 0.1 K_{Bst} | Therefore kinetic energy the ball on exit the semicircle reduces to: |
| 0.9 K_{Bst} | and is divided roughly equally between ball and engine: |
| K_{E} = 0.45 K_{Bst} + 0.1 K_{Bst} = 0.55 K_{Bst} | And kinetic energy the ball after exit the semicircle: |
| K_{B} = 0.45 K_{Bst} | |

It means that engine gets KE=0.55 of kinetic energy of the ball which is 5% over theoretically possible 50% allocation kinetic energy working substance to an engine employing Principle Conservation of Momentum that is used in current jet engines! A common sense gives ground for supposition that higher speed ball will cause more percent energy application to centrifugal force and hence engine. More over, with high enough speed the ball, the engine can get almost 100% kinetic energy of movement the ball. That means possibility practically double efficiency such engine with practically still positioning the ball at point leaving engine.

Let's examiner case when system engine-ball has close speed to speed the ball in space environment. In such scenario the ball transfers all its exceeding speed to centrifugal force and hence engine before leaving the semicircle. That means we can reverse running electromagnetic field and move the ball in opposite direction and create centrifugal force applying to engine again, that gives ground for assumption possibility design an engine operating without expulsion mass!

There are two other versions suggested concept of engine suitable for work without expulsion working substance shown on:

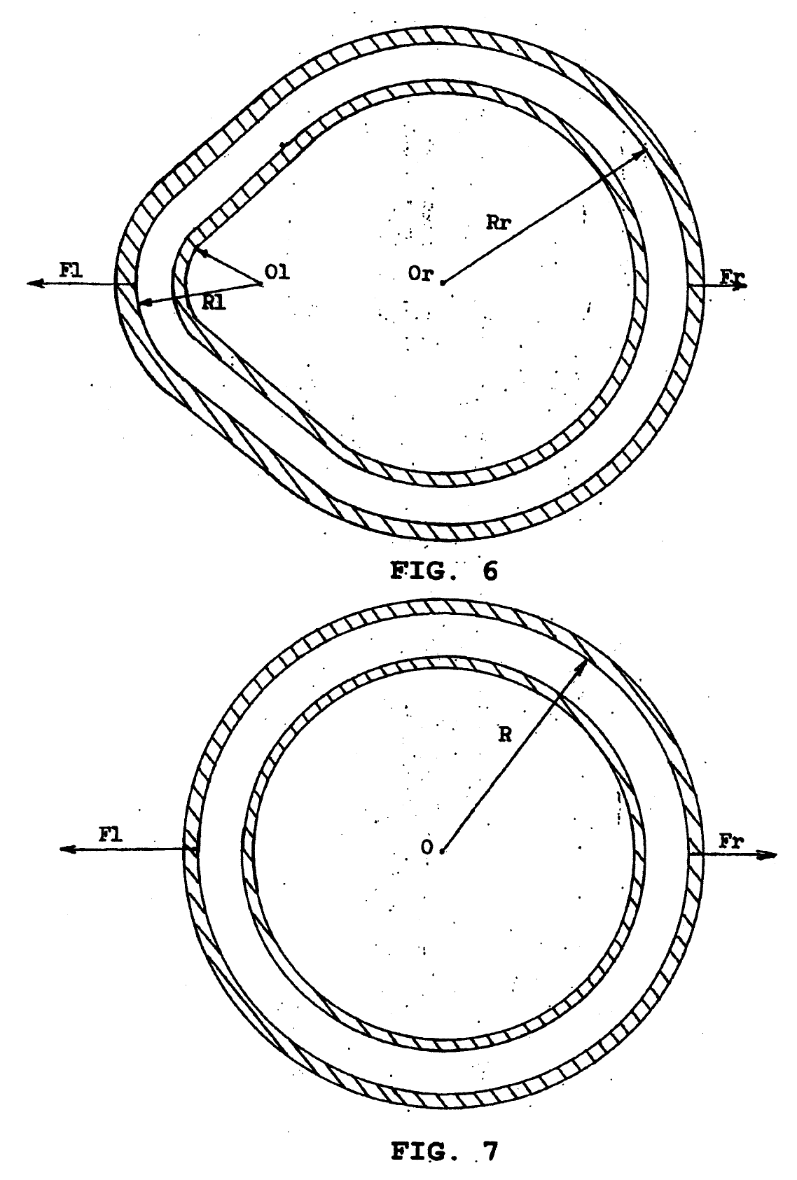

FIG. 6: Circular movement working body with different speed on opposite sides of circle arranged with:

a] Different length steps of electric power driven magnets on opposite sides;

b] Feeding of electric power driven magnets on opposite sides by different frequency voltage, ets

and FIG. 7: Circular movement working body with constant speed but with different radiuses on opposite sides of circle.

This version of novel design provides for:

Getting possibility to design economical, simple stable and therefore more reliable speedy and slow flying vehicle for lifting and transportation big and heavy loads, and therefore perfectly fit for controlling forest fires;

Getting possibility to design reliable, simple, small sized, and economical means for securing aircraft from uncontrolled downfall in the most accidents;

Getting possibility to design rotorless aircraft with variable lifting force enabling vertical take off;

Getting possibility to design economical and lightweight micro engine operated with ionized gas for correction orbit of a spacecraft.

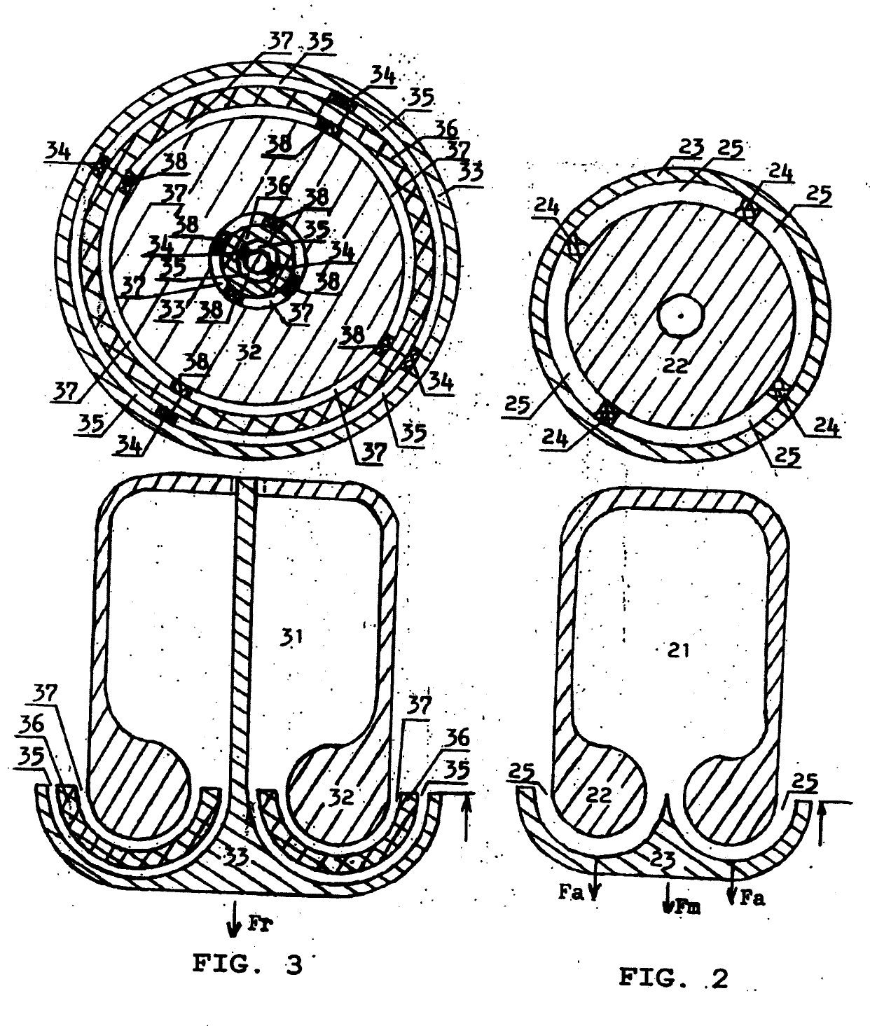

Referring now to FIG. 2, there are shown two sections of a gas driven linear mover with a single annular nozzle employing suggested design of centrifugal converter kinetic energy of a movement working substance in linear force.

This engine comprises a chamber of burning fuel 21, formed by closed cylinder 22, and cover 23 united by connectors 24. Its annular channel 25 for movement whole working substance also formed by cylinder 22, cover 23, and connectors 24. The movement working substance for example hot gas, via curved channel creates centrifugal force, applied to the outer surface curved channel 25. A resultant centrifugal force annular nozzle is shown Fₐ, and a resultant motive force of the engine is shown as Fₘ

One has admit that increase efficiency conversion kinetic energy movement working substance in linear force with centrifugal force is secured and it does not matter physical state of working substance.

The best efficiency attainable by this version engine would be channel allowing movement only one layer of liquid and practically attainable width the channel will be width allowing only laminar movement liquid working substance. Another essential factor for efficiency engine employing this concept is radius the circular channel, the less radius the more size force is produced.

Such design spreads application centrifugal force over lengthy space and therefore reduces specific load of surface, and reduces size of the engine.

This modification beneficial for:

Substitution current aircraft engines;

Design rockets with reduced load of fuel for the same range of operation;

Increase stability rockets in an active flight due the possibility installation a single mover before its center gravity;

Design small sized, reliable, and simple for activation solid fuel means of security aircraft from uncontrolled downfall in the most accidents.

Referring now to FIG. 3, there are shown two sections of a modification suggested design the linear mover with multiplied [double] annular nozzles employing the centrifugal converter.

This modification engine comprises a chamber of burning fuel 31 formed by a closed cylinder 32, an outer 33 and inner 36 covers united by connectors 34 and 38.

Its annular channel 37 for movement gases is formed by cylinder 32, an inner annular cover 36, connectors 38; its second annual channel 35 for movement gases is formed by inner annular cover 36, outer annual cover 33, and connectors 34.

The movement working substance, for example hot gas, via both curved channels creates a centrifugal force applied to the outer surface of the channels. The resultant motive force of the engine is shown by Fᵣ.

Such design spreads application centrifugal force over wider and longer surface, therefore reduces more specific load of surface, and also reduces more size of the engine.

The best efficiency attainable by this version engine would be channel allowing movement only one layer of liquid and practically attainable width the channel will be width allowing only laminar movement liquid working substance. Another essential factor for efficiency engine employing this concept is radius the circular channel, the less radius the more size force is produced.

This modification of engine also beneficial for:

Substitution current aircraft engines;

Design rockets with reduced load of fuel for the same range of operation;

Increase stability rockets in an active flight due the possibility installation a single mover before its center gravity;

Design small sized, reliable, and simple for activation solid fuel means of security aircraft from uncontrolled downfall in the most accidents.

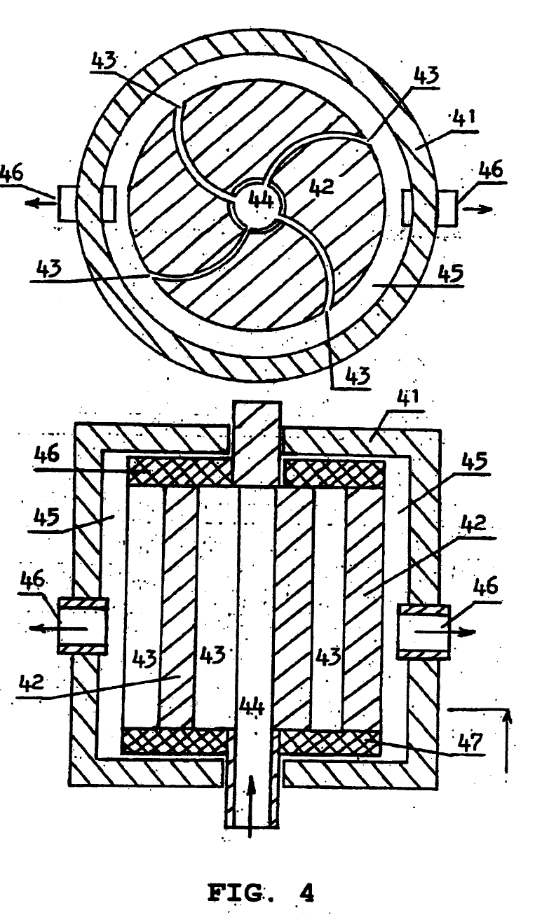

Referring now to FIG. 4, there are shown two sections of the novel design of an engine employing suggested converter kinetic energy of movement working substance in a rotary force.

This engine comprises a shell 41 a rotor 42; curved radial channels 43 for movement working substance from axial aperture 44 to out rotor room 45 and exhausts 46. The channel 43 is formed by curved radial slit in the rotor 42 and side rings 46 and 47.

The working substance, for example hot gas, feeds via aperture 44 to radial channels 43. The movement working substance via curved channels 43 creates a centrifugal force counterclockwise in shown example. After leaving channels 43, it is collecting in the out rotor room 45, and leaves engine via exhausts 46.

The best efficiency attainable by this version engine would be channel allowing movement only one layer of liquid and practically attainable width the channel will be width allowing only laminar movement liquid working substance. Another essential factor for efficiency engine employing this concept is radius the circular channel, the less radius the more size force is produced.

Such engine fits for substitution any conventional rotary engine; Can be designed with exclusively soft load characteristic that allows for example to manufacture a car without switching speed gear;

This design also beneficial for manufacturing hydraulic turbines for hydraulic power plants.

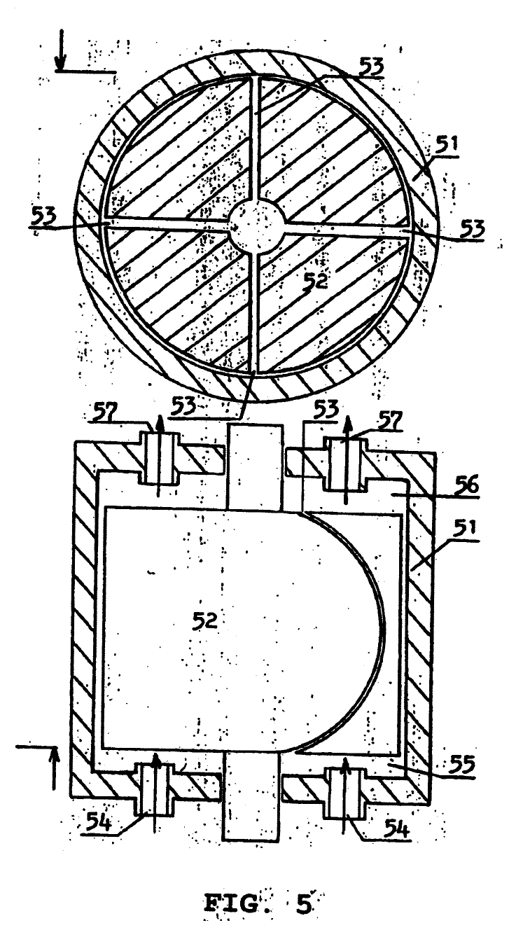

Referring now to FIG. 5, there are shown two sections of the novel design of an engine employing suggested centrifugal converter kinetic energy of movement working substance in a rotary force.

This modification engine comprises a shell 51; a rotor 52, with curved relatively axis the rotor radial channels 53 is formed by curved axial slit in the rotor for movement working substance; apertures 54; a pre rotor room 55; an after rotor room 56; and exhausts 57.

The working substance, for example hot gas, feeds via apertures 54 to the pre rotor room 55, curved channels 53, after rotor room 56, and exhausts 57.

The movement working substance via curved channel 53 creates a centrifugal force clockwise in shown example. After leaving channels 53, it is collecting in the after rotor room 56 and leaves the engine via exhausts 57.

The best efficiency attainable by this version engine would be channel allowing movement only one layer of liquid and practically attainable width the channel will be width allowing only laminar movement liquid working substance. Another essential factor for efficiency engine employing this concept is radius the circular channel, the less radius the more size force is produced.

Such engine fits for substitution any conventional rotary engine;

Can be designed with exclusively soft load characteristic that allows for example to manufacture a car without switching speed gear;

This design also beneficial for manufacturing hydraulic turbines for hydraulic power plants.

Referring now to FIG. 6, there is shown section of the novel design of linear engine without expelling mass employing suggested centrifugal converter kinetic energy of movement working substance in a linear force by driving it in a circle with different radiuses on opposite sides.

This modification engine comprises a channel for movement working substance 61 with radiuses Rᵣ=2R₁ with centers O1 and Or located on opposite sides the channel; an outer 62 and inner 63 walls of curvilinear surface lined inside with electric magnets fed by multiphase voltage for creating running electromagnetic field for driving ball or rod 64, that creates different centrifugal forces F₁ and Fᵣ on opposite sides the channel. Its resultant linear force F₁=F₁−Fᵣ that is a difference centrifugal forces are creating by ball or rod running with different speed on opposite sides. The stability the force can be secured by driving two or more balls on opposite sides simultaneously.

$${F}_{3} = \frac{M * {V}^{2}}{{R}_{2}} {F}_{4} = \frac{M * {V}^{2}}{2 {R}_{2}}$$

With summary centrifugal

$${F}_{SB} = {F}_{3} - {F}_{4} = \frac{M * {V}^{2}}{{R}_{2}} - \frac{M * {V}^{2}}{2 {R}_{2}} = \frac{1}{2} * \frac{M * {V}^{2}}{{R}_{2}}$$

A ball or rod is being forced to rotate along circular surface by running electromagnetic field in a way securing the same speed.

Say movement the ball or rod segment along of the circumference with bigger radius creates less size centrifugal force and therefore consumers and thus transfers less electric power to centrifugal force, and movement the ball or rod segment along the of the circumference with smaller radius creates bigger volume centrifugal force and thus consumers and so transfers more electric power to centrifugal force.

A calculations shown in example with doubled radius on an opposite side of the circumference demonstrates possibility to obtain summary linear force equal to half one created by the shortest radius.

Such engine employing as a working substance ionized gas is very valuable for design low weight mini and even micro engines for space and interstellar applications. However such design can be valuable also for terrestrial applications, say for watercraft.

Referring now to FIG. 7, there is shown section of the novel design of linear engine without expelling mass by employing suggested centrifugal converter kinetic energy of movement working substance in a linear force with movement ball or rod in circle with different speed on opposite sides. It employs difference centrifugal forces are creating by ball or rod running with different speed on opposite sides.

This modification engine comprises a channel for movement working substance 71 with radius R at centers O; an outer 72 and inner 73 walls of circle lined inside with electric magnets fed by multiphase voltage for creating running electromagnetic field for driving ball or rod 74, that creates different centrifugal forces F₁ and Fᵣ on opposite sides the circular channel.

It creates linear force F₁=F₁−Fᵣ that is a difference centrifugal forces are creating by ball or rod running with different speed on opposite sides. The stability the force can be secured by driving two or more balls or rods on opposite sides simultaneously.

A ball or rod is being forced to rotate along circular surface by running electromagnetic field with different speeds on opposite sides of a circumference.

$${F}_{1} = \frac{M * {V}^{2}}{{R}_{1}} {F}_{2} = \frac{m * 2 V * 2 V}{{R}_{1}} = \frac{m * 4 * {V}^{2}}{{R}_{1}}$$

With resultant centrifugal

$${F}_{RA} = {F}_{2} - {F}_{1} = \frac{m * 4 {V}^{2}}{{R}_{1}} - \frac{m * {V}^{2}}{{R}_{1}} = 3 * \frac{m * {V}^{2}}{{R}_{1}}$$

Accordingly, the segment of the circumference with smaller speed creates less size centrifugal force and therefore consumers and transfers to the ball or cylinder less electric power and the segment of circumference with bigger speed creates bigger size centrifugal force and therefore consumers and so transfers more electric power to the ball or rod. A calculations shown in example with doubled speed on an opposite side of the circumference demonstrates possibility to obtain net linear force equal to triple one created by the lowest speed movement the ball or rod.

Let's examiner opportunity use this version design for terrestrial application. If we manufacture a circuit with diameter 1 meter lined with electric magnets and feed them with 3 phase electric power providing say to 2 kg ball or rod speed rotation say 3000 r/m or 50 r/sec, then the ball will create centrifugal force:

$${F}_{C1} = m * \frac{{V}^{2}}{0.5} = \frac{2 * {[ 3.14 * 50 ]}^{2}}{0.5} = \frac{2 * {[ 157 ]}^{2}}{0.5} * \frac{2 * 24649}{0.5} = 98.6 T .$$

When we feed its one semicircle with multi phase electric voltage for providing speed rotation 3000 r/m=linear speed 565.2 km/hr to the ball and the other semicircle say will feed voltage with reduced frequency for providing to the ball or rod speed of rotation say 2700 r/m or 45 r/sec, the ball will create centrifugal force:

$${F}_{C2} = \frac{2 * {[ 3.14 * 45 ]}^{2}}{0.5} = \frac{2 * {[ 141 ]}^{2}}{0.5} = \frac{2 * 19881}{0.5} = 79.52 T .$$

Accordingly, summary centrifugal force will be:

F_{CS}=F_{C1}−F_{C2}=98.6−79.52=19.08 T. directed roughly toward middle high speed semicircle! Such motive linear force contrary currently used on water vessels comes without need to move in opposite direction 19.08 T water, that means over 100% increase efficiency, consider eliminated loss energy to power transmission equipment!

Centrifugal versions engine without expelling mass actually exploits feature transferring kinetic energy of a ball or rod during braking to a storage[in potential energy] and from storage to kinetic energy the ball during acceleration and maintaining speed on active path. This feature secured by nature law of synchronization running electromagnetic field. It is well known effect, Three-phase electric motor consumers electric power when its speed rotation is bellow synchronic for given frequency 3-phase voltage and given design a motor. The bigger difference speeds—the bigger power consumption. If the speed of rotation of the electric motor equals to synchronic for ones, the motor doesn't consumer any energy. When speed rotation of such electric motor excesses synchronous—the motor starts generate electric power. The bigger difference between speed rotation of such electric motor with synchronous for given frequency 3-phase voltage—the more electric power is generated by the motor. This modification engine employing as a working substance ionized gas is very valuable for design low weight mini and even micro engines for space and interstellar applications. However such design can be valuable also for terrestrial applications, say for watercraft.

While the invention has been particularly shown and described with respect preferred embodiments thereof, it should be understood by those skilled in the art that the foregoing and other changes in form and details may be made without departing from the spirit scope of the invention which should be limited only by scope of the appended claims.

What is claimed:

1. Concept increasing efficiency conversion kinetic energy in linear and rotary force, characterized employment a centrifugal force;
said centrifugal force is created by a movement working substance selected from a group comprising rolling elements, liquid, ionized gas,
said movement working substance is driven by a force means selected from a group comprising running electromagnetic field, pressure liquid, burning fuel, along a semicircular surface with a movement managing means defining predetermined dimensions working said semicircular surface selected from of group like rigid inner wall, rigid outer wall, side walls of channels whereby enabling creating and transfer the centrifugal force by a whole mass of the moving working substance to the semicircular surface and thus engine.

2. The Concept Increasing Efficiency Conversion Kinetic Energy In Linear And Rotary Force, of claim 1, wherein the working semicircular surface is coated with durable means selected from group oxides metals ceramic.

3. The Concept Increasing Efficiency Conversion Kinetic Energy In Linear And Rotary Force, of claim 1, wherein the moving working substance is gas driven by pressure of burning fuel.

4. The Concept Increasing Efficiency Conversion Kinetic Energy In Linear And Rotary Force, of claim 3, wherein the semicircular surface has annular shape whereby providing increased length line creating the centrifugal force with increased volume the working substance and reduced specific load on the working surface.

5. The Concept Increasing Efficiency Conversion Kinetic Energy In Linear And Rotary Force, of claim 3, wherein the semicircular surface has multiplied annular shapes whereby providing further increased length line creating the centrifugal force with further increased volume the working substance and further reduced specific load on the working surface.

6. The Concept Increasing Efficiency Conversion Kinetic Energy In Linear And Rotary Force, of claim 1, wherein the moving working substance is said electrically conductive liquid driven by pressure of said running electromagnetic field.

7. The Concept Increasing Efficiency Conversion Kinetic Energy In Linear And Rotary Force, of claim 1, wherein the moving working substance is said rolling element selected from group comprising balls and rods driven by pressure of the running electromagnetic field.

8. The Concept Increasing Efficiency Conversion Kinetic Energy In Linear And Rotary Force, of claim 1, wherein the centrifugal force is created by the movement of said liquid working substance via the semicircular surface arranged radially on axis rotation whereby providing rotary force.

9. The Concept Increasing Efficiency Conversion Kinetic Energy In Linear And Rotary Force, of claim 1, wherein the centrifugal force is created by the movement of said liquid working substance via a plurality channels with a multiplied semicircular surfaces in form channels with predetermined radius, shape and sizes arranged axially on axis rotation whereby providing rotary force.

10. The Concept Increasing Efficiency Conversion Kinetic Energy In Linear And Rotary Force, of claim 9, wherein said plurality channels with said multiplied semicircular surfaces arranged axially on axis rotation are multiplied and installed one after another, whereby providing further increased length line creating the centrifugal force with further increased volume the working substance and further reduced specific load on the working surface.

11. The Concept Increasing Efficiency Conversion Kinetic Energy In Linear And Rotary Force, of claim 9, wherein the plurality channels with the multiplied semicircular surfaces coated by durability increasing means selected from group metals, oxides, ceramics.

12. The Concept Increasing Efficiency Conversion Kinetic Energy In Linear And Rotary Force, of claim 9, wherein the liquid working substance is selected from group comprising matter like gas, water.

13. The Concept Increasing Efficiency Conversion Kinetic Energy In linear And Rotary Force, of claim 1, wherein the working semicircular surface further including an adjusted semicircular surface whereby providing ability to the working substance run both semicircular surfaces sequentially.

14. The Concept Increasing Efficiency Conversion Kinetic Energy In Linear And Rotary Force, of claim 13, wherein said adjusted semicircular surface further has a different radius whereby securing creation by the running working substance the centrifugal force different size on opposite sides a circuit sequentially.

15. The Concept Increasing Efficiency Conversion Kinetic Energy In Linear And Rotary Force, of claim 13, further comprising means for moving the working substance, selected from said group including balls, rods, ionized gas, with different speed on opposite sides said circuit sequentially, whereby securing creation by the running working substance the centrifugal force different size on opposite sides said circuit sequentially.
